(19) United States
(12) Patent Application Publication
(10) Pub. No.: US 2009/0267271 A1
(43) Pub. Date: Oct. 29, 2009

(54) method of producing the plastic bottle that emit FIR

(76) Inventor: Duck Hoon Kim, San Francisco, CA (US)

Correspondence Address: Young S. Kim, 1844 Balboa Street, San Francisco, CA, 94121, US

(21) Appl. No.: 12/108,501

(22) Filed: Apr. 23, 2008

(51) Int. Cl. B29C 49/06

(52) U.S. Cl. 264/513

(57) ABSTRACT

This invention relates plastic bottles and a method thereof, said bottles are formed of plastic materials with the incorporation of Optimum Resonant (different types of mineral elements) that naturally emit 6˜10 μm wave length of far infrared radiation (FIR), allowing the beverages (especially drinking water) to be kept fresh with soft taste. Said bottles can be Ionize and alkalize its contents after bottling until it consumed by the end user/consumer to provide benefits to both consumers and suppliers. Plastic bottles used in storing, carrying, packaging, protecting of water, beverage, milk, eggs are disclosed.

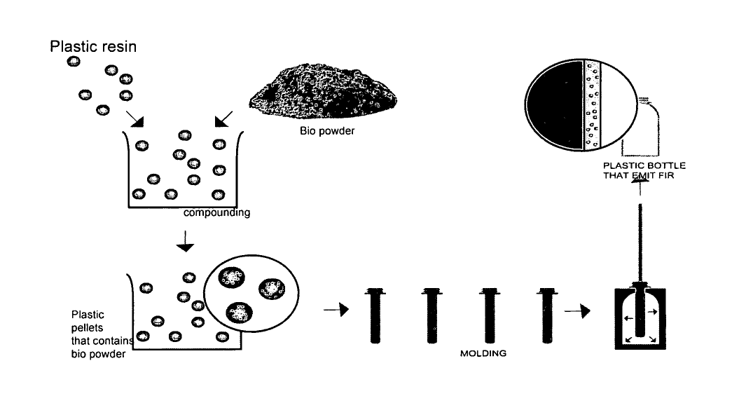

### REFERENCE

1. Theory and Practice for Heating of FIR by Far Infrared Rays committee of Japan

2. Sunlight, Zane Kime, M. D., Pengrove, Calif., World Health Publications, 1980 Articles on Light Therapy, pg 261

3. Bulletin of the School of Agriculture, Meiji University title: Effects of Far-infrared ray (FIR) irradiation on reproduction, growth, behavior and some physiological parameter by NAGASAWA H (Meiji Univ.) KOIKE T (Meiji Univ.) UDAGAWAY (Meiji Univ.)

4. Bioceramics and their clinical applications by T. Kokubo

### DESCRIPTION OF INVENTION

### BRIEF SUMMARY

This invention regards the producing and manufacturing processes of plastic bottles that emit far infrared radiation, made from incorporating Optimum Resonant (Mixture of many different varieties of minerals elements) and plastic resin such as PP, PE, PET, allowing the water products including drinking water, beverages etc. to be kept fresh. More descriptively, this invention deals with the production and manufacturing processes of plastic bottles that involve using the Bio-powder made up of the powdered bio-stone and clay minerals (naturally chelated trace minerals) fused with Plastic resin to make it into pellets, forming it into plastic bottles, which will then emit far infrared radiation, ionizing, keeping and extending the freshness of the water, to increase the health benefits to consumers.

### BACKGROUND

Water is essential for the survival of all known forms of life. According to the Institute of Medicine, on average women consume 2.2 litres and men 3.0 litres of water daily. Also noted is that normally, about 20 percent of the water intake comes from food, while the rest comes from drinking water and beverages. The latest dietary reference intake report by the United States National Research Council notes that in general, the recommended (including food sources) amount of water intake is 2.7 liters total for women and 3.7 liters total for men.

But the water quality has always been a concern for the government and the consumers. In fact, about 1 billion people around the world routinely drink unhealthy water, although poor water quality and bad sanitation can be deadly—about 5 million deaths a year are caused by drinking polluted water. WHO (World Health Organization) and most countries are trying to reduce the number of people worldwide who do not have access to safe water and sanitation.

Plastic based bottles made of PP, PE, PET is widely used for bottling, storing and supplying the purified and/or spring water as well as other beverages because the plastic material is light in weight with high density and has a reasonable cost of manufacturing. But the water products' quality is not that easy to keep fresh during transportation, storing and supplying, because the plastic material of the bottles itself does not have any antifungal, disinfectant, odor removal effect, but is a source of the endocrine disrupter.

By incorporating Optimum Resonant (different types of mineral elements that emit far infrared radiation) in the plastic resin that the plastic bottle are made of, water and beverage will be kept fresh for a longer period of time with better and soft taste, providing health benefits to the consumers and the suppliers.

Technical Issues the Invention is Aimed at Achieving:

The purpose/goal of this invention is aimed at producing and manufacturing the plastic resin based bottles that help extend the freshness of the water and beverages, and gets rid of foul odors for better quality and taste. These plastic resin based bottles will emit high amounts of far infrared radiation as it is made of mixed substances that emit such radiation.

Invention's Composition and Function:

Bio Stone is comprised of silicon dioxide (SiO), and aluminum oxide etc., making it possible to emit far infrared radiation, and the efficiency is excellent, with 92-93% radiation. Having electrical characteristics, the positive pole absorbs the negative ions and the negative pole discharges negative ions, producing continuous electric current of 0.06 mA and instantaneously releasing it in the air. As a natural source of far infrared ray, it is known as a mineral that helps to relieve stress, improve blood circulation as well as immunity.

This bio stone is known to accelerate the metabolization of animals and plants, and help deodorize scents, prevent bacterial growth, soften hard water, relieve pain, purify water and air, improve strength and health, normalize blood cholesterol, prevent mold, maintain body warmth, allow better sleep, enhance and maintain freshness of foods, and accelerate the alkalization of the food fluids by the emission of FIR. General formula of Bio-stone can be written as: XY3Z6(T6O18)(BO3)3V3W

Clay Mineral is naturally chelated trace minerals made of volcanic ashes accumulated at the bottom of lakes, and is formed of all natural 78 mineral elements and it's basic structure is MgO Al2 O2.SiO2 nH2O.

Aluminum Al
Antimony Sb
Arsenic As
Barium Ba
Beryllium Be
Bismuth Bi
Boron B
Bromine Br
Cadmium Cd
Calcium Ca
Carbon C
Cerium Ce
Cesium Cs
Chlorine Cl
Chromium Cr
Cobalt Co
Copper Cu
Dysprosium Dy
Erbium Er
Europium Eu
Fluorine F
Gadolinium Gd
Gallium Ga
Germanium Ge
Gold Au
Hafnium Hf
Holmium Ho
Hydrogen H
Indium In
Iodine I
Iridium Ir
Iron Fe
Lanthanum La
Lead Pb
Lithium Li
Lutetium Lu
Manganese Mn
Magnesium Mg
Mercury Hg
Molybdenum Mo
Neodymium Nd
Nickel Ni
Niobium Nb
Nitrogen N
Osmium Os
Oxygen O
Palladium Pd
Phosphorus P
Platinum Pt
Potassium K
Praseodymium Pr
Rhenium Re
Rhodium Rh
Rubidium Rb
Ruthenium Ru
Samarium Sm
Scandium Sc
Selenium Se
Silicon Si
Silver Ag
Sodium Na
Strontium Sr
Sulphur S
Tantalum Ta
Tellurium Te
Terbium Tb
Thallium Tl
Thorium Th
Thulium Tm
Tin Sn
Titanium Ti
Tungsten W
Uranium U
Vanadium V
Ytterbium Yb
Yttrium Y
Zinc Zn
Zirconium Zr

This clay mineral, also like the bio stone, emit FIR (far infrared ray) and does not have any hazardous components but absorbs hazardous substances in bodies, and has the effects of medical treatments and tranquilizers. Due to the enzyme's catalysis it helps with metabolization, muscle functions, cell creations/restorations and growth. These mineral elements provide biological benefits in live cells, and are essential to all living lives' growth, whether plants or animals.

By incorporating these essential mineral elements in plastic resin along with the powdered bio stone, it will help extend the time of water and beverage keeping and freshness. (Experiment result: page 11)

This invention involves using the maximum benefits of the FIR (far infrared ray) emitted by the bio stone and clay minerals by mixing the right ratio of mineral powders into plastic resin, compounding, creating pellets, molding it into plastic bottles, which would then enhance and maintain the freshness, prevent bacterial growth, extend the shelve life, help ionized and alkalize, as well as soften the water.

The temperature in which the bottles that contain the bio-powder emit the highest amount of far infrared radiation is 33˜47 degrees Celsius, but it is best to keep the bottles at the temperature of 38˜42 degrees Celsius in order to achieve and maintain best results.

### DETAILED DESCRIPTION: (DRAWING: PAGE 10)

The processing method of these bottles is:

1. Bio-powder: Preparing the bio-stone and clay minerals into sizes under 20 μm particle.

2. Compounding: mixing plastic resin and the bio-powder in extruding type compounding machine to create the pellets type plastic chip.

3. Molding step: taking the plastic pellets from step 2 into molding machine and perform injection molding.

4. Finishing: blow high pressured air into the molded plastic (if necessary) to make them into bottles, then finishing and perfect them as products.

The preparation for the bio-powder is grinding the bio-stone and the clay minerals in the weight ratio of 20˜30% to the total weight of the bio-stone (100%) to smaller than 20 μm particles.

Compounding step is mixing the Plastic resin materials and the bio-powder into the fixed ratio, and compounding them to make it into pellet type plastic chips.

The main materials consist of the mixture of plastic resin (70-99% weight) and the bio-powder (1˜30% weight), and the bio-powder consists of the mixture of the bio-stone and the clay minerals smaller than 20 μm particles. The greater the ratio of the bio-powder is to plastic resin, the greater the far infrared radiation emitted from the containers would be; but if the ratio of the bio-powder exceeds 15% of the total weight, the unique resilient characteristics of the plastic will be lost, making the finished container products to be defected with air holes or pin holes.

The bio-powder mix used in this invention has high emissivity of far infrared radiation, producing great results even with small amounts, which means that only 1˜5% weight of the bio-powder can be added to 95˜99% weight of the plastic resin and still achieve great results.

The molding step is taking the well compounded plastic pellets right after polymerization process and putting it in a molding machine and making it into necessary plastic bottle shapes.

The plastic bottles that are made from this process will have small amount of the bio-powder evenly distributed, maintaining the plastic's unique resiliency as well as the elasticity and at the same time emit far infrared radiation, helping the water and beverages to be kept in optimum condition, become alkalized, and for the freshness to be enhanced and maintained. It will also prevent bacterial growth, minimize bad odors, and extend the shelf life of the drinking water and beverages, providing benefits to both consumers and suppliers. Also, the manufacturing process is simple and the commercial use will be easy/wide, benefiting both manufacturers as well as the consumers.

1. The preparation for the bio-powder consists of the mixture of powdered bio-stone and the clay mineral that naturally chelated trace mineral complex in the sizes smaller than 20 μm particles.

2. Mixing the plastic resin (i.e. PET, PE, PP) with the bio-powder

3. Polymerization of the mixture in the compounding machine makes it into pellets type

4. Perform injection molding by using the molding machine, and blow it with high air pressure to make the bottles that contain the bio powder

5. The main materials consist of the mixture of Plastic Resin (70˜99% weight) and the bio-powder (1˜30% weight).
